(19) United States
(12) Patent Application Publication
(10) Pub. No.: US 2014/0120282 A1
(43) Pub. Date: May 1, 2014

(54) Multi-Layered Co-Injection Molded Article

(71) Applicant: Ticona LLC, Florence, KY (US)

(72) Inventors: Young Shin Kim, Erlanger, KY (US); Xinyu Zhao, Cincinnati, OH (US)

(73) Assignee: Ticona LLC, Florence, KY (US)

(21) Appl. No.: 14/066,726

(22) Filed: Oct. 30, 2013

Related U.S. Application Data
(60) Provisional application No. 61/721,107, filed on Nov. 1, 2012.
(60) Provisional application No. 61/778,897, filed on Mar. 13, 2013.

(51) Int. Cl. B32B 27/08; B65D 1/40; B29C 45/16

(52) U.S. Cl. CPC B32B 27/08; B29C 45/164; B65D 1/40
USPC 428/35.7; 264/241; 428/212

(57) ABSTRACT

A multi-layered, co-injection molded article is disclosed that includes a barrier layer that is formed from a thermotropic liquid crystalline polymer and disposed adjacent to a protective layer, which is formed from a base polymer (e.g., olefinic polymer).

### RELATED APPLICATIONS

The present application claims priority to U.S. Provisional Application Ser. Nos. 61/721,107 (filed on Nov. 1, 2012) and 61/778,897 (filed on Mar. 13, 2013), which are incorporated herein in their entirety by reference thereto.

### BACKGROUND OF THE INVENTION

Multi-layered articles are commonly employed as containers for various food and medicine packaging applications. Such containers are typically formed by co-injection molding polypropylene (“PP”) and ethylene vinyl alcohol (“EVOH”) in a two- or three-layered configuration. In these containers, the EVOH layer serves as a barrier layer due to its ability to limit the transmission of oxygen therethrough. Unfortunately, one of the problems commonly associated with EVOH is that it has relatively poor barrier properties to moisture, and it also tends to lose its oxygen transmission resistance at higher temperatures, which can limit its use in applications in which heating is required (e.g., retort packaging). To overcome these issues, proposals have been made to use a liquid crystalline polymer (“LOP”) layer as a substitute for the EVOH layer in co-injection, multi-layered molded articles due to its excellent barrier properties to both oxygen and moisture. While an attractive option, the use of LOP layers in multi-layered articles has been limited due to the difficulty experienced in co-injection molding such polymers with polypropylene. In some cases, for example, the LCP polymer can actually blend with the polypropylene during the injection process, which significantly reduces the barrier properties for the resulting article.

As such, a need currently exists for an improved technique for incorporating a barrier layer into a co-injection molded, multi-layered article.

### SUMMARY OF THE INVENTION

In accordance with one embodiment of the present invention, a multi-layered, co-injection molded article is disclosed that comprises a barrier layer and a protective layer. The barrier layer comprises a thermotropic liquid crystalline polymer having a melting temperature of from about 190° C. to about 360° C., the liquid crystalline polymer comprising aromatic ester repeating units. The protective layer comprises a base polymer. The ratio of the melting temperature of the liquid crystalline polymer to the melting temperature of the base polymer is from about 1.00 to about 1.70.

In accordance with another embodiment of the present invention, a method for forming a multi-layered article is disclosed. The method comprises co-injecting a liquid crystalline polymer composition and a base polymer composition into a mold cavity. The base polymer composition comprises a base polymer and the liquid crystalline polymer composition comprises a thermotropic liquid crystalline polymer having a melting temperature of from about 190° C. to about 360° C., the liquid crystalline polymer comprising aromatic ester repeating units. The ratio of the melting temperature of the liquid crystalline polymer to the melting temperature of the base polymer is from about 1.00 to about 1.70. The co-injected compositions are cooled to form the article.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a cross-sectional view of one embodiment of a co-injection molding manifold that may be employed in the present invention;

FIG. 2 is a perspective view of one embodiment of a multi-layered article that may be formed in accordance with the present invention;

FIG. 3 is a horizontal sectional view of the article of FIG. 2 taken along line 3-3 thereof; and

FIG. 4 illustrates a section of the article of FIG. 2 along line 4-4.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a multi-layered, co-injection molded article. The article includes a barrier layer that is formed from a thermotropic liquid crystalline polymer and disposed adjacent to a protective layer, which is formed from a base polymer. The present inventors have discovered that by selectively controlling the specific nature of the liquid crystalline and base polymers, the quality of the co-injection molded article can be improved. For example, the thermal properties of the polymers are selectively controlled so that only a minimal amount of heat is transferred from the liquid crystalline polymer to the base polymer during the molding operation. This reduces the likelihood of the base polymer softening or melting, which could otherwise result in blending of the polymers. Limiting the degree of heat transfer can also minimize the energy released by the liquid crystalline polymer so that it does not undergo a phase transition and “freeze” in the molding apparatus.

In this regard, the liquid crystalline polymer has a melting temperature that is higher than the melting temperature of the base polymer, yet low enough to minimize the adverse impacts of heat transfer. More particularly, the ratio of the melting temperature of the liquid crystalline polymer to the melting temperature of the base polymers is selectively controlled within a narrowly defined range of from about 1.00 to about 1.70, in some embodiments from about 1.05 to about 1.50, and in some embodiments, from about 1.10 to about 1.40. The melting temperature of the liquid crystalline polymer may, for instance, range from about 190° C. to about 360° C., in some embodiments from about 190° C. to about 320° C., in some embodiments from about 190° C. to about 260° C., in some embodiments from about 200° C. to about 240° C., and in some embodiments, from about 210° C. to about 230° C. The melting temperature of the base polymer may likewise range from about 140° C. to about 250° C., in some embodiments from about 140° C. to about 190° C., in some embodiments from about 150° C. to about 180° C., and in some embodiments, from about 155° C. to about 175° C.

In addition to having a certain melting temperature, other thermal properties of the liquid crystalline polymer may also be selected to achieve the desired multi-layered article. For example, the liquid crystalline polymer may be formed so that it is a “liquid-like” material to the extent that it has a relatively low storage modulus and/or low shear thinning behavior. The storage modulus may, for instance, be about 100 Pa or less, in some embodiments about 50 Pa or less, and in some embodiments, from 1 to about 40 Pa, as determined at the melting temperature and at an angular frequency of 0.1 rad/s. The complex viscosity of the liquid crystalline polymer, which is representative of its shear thinning behavior, may also be about 2,500 Pa-s or less, in some embodiments about 1,500 Pa-s or less, in some embodiments from about 100 to about 1,000 Pa-s at angular frequencies ranging from 0.1 to 1000 radians per second (e.g. 0.1 radians per second). The complex viscosity may be determined by a parallel plate rheometer at 15° C. above the melting temperature and at a constant strain amplitude of 1%. Likewise, the liquid crystalline polymer may have a melt viscosity of from about 1 to about 150 Pa-s, in some embodiments from about 2 to about 125 Pa-s, and in some embodiments, from about 5 to about 100 Pa-s, determined at a shear rate of 1000 seconds⁻¹. Melt viscosity may be determined in accordance with ISO Test No, 11443 at 15° C. above the melting temperature of the polymer.

Various embodiments of the present invention will now be described in more detail.

### I. Barrier Layer

As indicated above, the barrier layer is formed from a composition that contains at least one thermotropic liquid crystalline polymer, which is capable of possessing a high degree of crystallinity and good barrier properties. Liquid crystalline polymers are generally classified as “thermotropic” to the extent that they can possess a rod-like structure and exhibit a crystalline behavior in its molten state (e.g., thermotropic nematic state). Such polymers may be formed from one or more types of repeating units as is known in the art. The liquid crystalline polymer may, for example, contain one or more aromatic ester repeating units, typically in an amount of from about 60 mol. % to about 99.9 mol. %, in some embodiments from about 70 mol. % to about 99.5 mol. %, and in some embodiments, from about 80 mol. % to about 99 mol. % of the polymer. The aromatic ester repeating units may be generally represented by the following Formula (I):

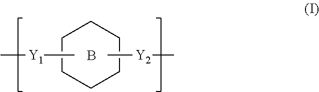

wherein,

ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and

Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic dicarboxylic repeating units, for instance, may be employed that are derived from aromatic dicarboxylic acids, such as terephthalic acid, isophthalic acid, 2,6-naphthalenedicarboxylic acid, diphenyl ether-4,4″-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) typically constitute from about 2 mol. % to about 50 mol. %, in some embodiments from about 5 mol. % to about 45 mol. %, and in some embodiments, from about 10 mol. % to about 40% of the polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute from about 10 mol. % to about 85 mol. %, in some embodiments from about 20 mol. % to about 80 mol. %, and in some embodiments, from about 25 mol. % to about 75% of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 35 mol. %, in some embodiments from about 2 mol. % to about 30 mol. %, and in some embodiments, from about 5 mol. % to about 25% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10% of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, dials, amides, amines, etc. Of course, in other embodiments, the polymer may be “wholly aromatic” in that it lacks repeating units derived from non-aromatic (e.g., aliphatic or cycloaliphatic) monomers.

In one particular embodiment, the liquid crystalline polymer may be formed from repeating units derived from 4-hydroxybenzoic acid, (“HBA”), 6-hydroxy-2-naphthoic acid (“H NA”), and terephthalic acid (“TA”) and/or isophthalic acid (“IA”), as well as various other optional constituents. The repeating units derived from HBA may constitute from about 10 mol. % to about 50 mol. %, in some embodiments from about 15 mol. % to about 45 mol. %, and in some embodiments, from about 20 mol. % to about 40% of the polymer. The repeating units derived from HNA may constitute from about 10 mol. % to about 50 mol. %, in some embodiments from about 15 mol. % to about 45 mol. %, and in some embodiments, from about 20 mol. % to about 40% of the polymer. The repeating units derived from terephthalic acid (“TA”) and/or isophthalic acid (“IA”) may likewise constitute from about 5 mol. % to about 40 mol. %, in some embodiments from about 10 mol. % to about 35 mol. %, and in some embodiments, from about 15 mol. % to about 35% of the polymer. Repeating units may also be employed that are derived from 4,4′-biphenol (“BP”) and/or hydroquinone (“HQ”) in an amount from about 1 mol. % to about 35 mol. %, in some embodiments from about 2 mol. % to about 30 mol. %, and in some embodiments, from about 5 mol. % to about 25% of the polymer. Other possible repeating units may include those derived from 2,6-naphthalenedicarboxylic acid (“NDA”) and/or acetaminophen (“APAP”). In certain embodiments, for example, repeating units derived from NDA and/or APAP may each constitute from about 1 mol. % to about 35 mol. %, in some embodiments from about 2 mol. % to about 30 mol. %, and in some embodiments, from about 3 mol. % to about 25 mol. % when employed.

Regardless of the particular constituents and nature of the polymer, the liquid crystalline polymer may be prepared by initially introducing the aromatic monomer(s) used to form ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 190° C. to about 260° C., in some embodiments from about 200° C. to about 240° C., and in some embodiments, from about 210° C. to about 230° C. For instance, one suitable technique for forming the liquid crystalline polymer may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 190° C. to about 260° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. In some embodiments, the melt polymerized polymer may also be subjected to a subsequent solid-state polymerization method to further increase its molecular weight. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 150° C. to about 250° C. The polymerization time will of course vary based on the temperature and target molecular weight. In most cases, however, the solid-state polymerization time will be from about 2 to about 12 hours, and in some embodiments, from about 4 to about 10 hours.

To maintain the desired properties, the majority of the composition used in the barrier layer is generally formed from liquid crystalline polymers. That is, about 50 wt. % or more, in some embodiments about 75 wt. % or more, and in some embodiments, about 90 wt. % or more (e.g., 100 wt. %) of the composition is formed by liquid crystalline polymers. Nevertheless, the composition used in the barrier layer may optionally contain one or more additives if so desired, such as flow aids, antimicrobials, pigments, antioxidants, stabilizers, surfactants, waxes, solid solvents, flame retardants, anti-drip additives, and other materials added to enhance properties and processability.

Fibrous fillers, for instance, may be employed to help improve strength. Examples of such fibrous fillers may include those formed from glass, carbon, ceramics (e.g., alumina or silica), aramids (e.g., Kevlar® marketed by E. I. DuPont de Nemours, Wilmington, Del.), polyolefins, polyesters, etc., as well as mixtures thereof. Glass fibers are particularly suitable, such as E-glass, A-glass, C-glass, D-glass, AR-glass, R-glass, S1-glass, S2-glass, etc., and mixtures thereof. Particulate fillers may also be employed in the polymer composition to help achieve the desired properties and/or color. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), Mite ((K,H₃O)(Al,Mg,Fe)₂ (Si,Al)₄O₁₀[(OH)₂,(H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂.4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other particulate fillers may also be employed. For example, other suitable silicate fillers may also be employed, such as calcium silicate, aluminum silicate, mica, diatomaceous earth, wollastonite, and so forth. Mica, for instance, may be a particularly suitable mineral for use in the present invention. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof.

Lubricants may also be employed that are capable of withstanding the processing conditions of the liquid crystalline polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide.

When employed, the optional additive(s) typically constitute from about 0.05 wt. % to about 20 wt. %, and in some embodiments, from about 0.1 wt. % to about 15 wt. %, and in some embodiments, from about 0.5 wt. % to about 5 wt. % of the barrier layer.

### II. Protective Layer

As indicated above, the protective layer of the multi-layered article contains a base polymer, such as an olefinic polymer, polyester (e.g., PBT, PET, etc.), polyimide, polyamide, etc. Olefinic polymers may be particularly suitable, such as a propylene polymer, ethylene polymer, etc., as well as combinations thereof. In one embodiment, for example, the protective layer may contain a homopolymer of propylene (e.g., substantially syndiotactic polypropylene, substantially isotactic polypropylene, etc., as well as blends thereof) and/or a homopolymer of ethylene (e.g., ultrahigh molecular weight polyethylene (“UHMWPE”), high density polyethylene (“HDPE”), etc., as well as blends thereof). Such homopolymers typically include about 1 mole % or less of other comonomers (e.g., 0 mole % of other comonomers). Of course, olefinic copolymers (e.g., random copolymers or block copolymers) may also be employed in the present invention. One example of such a copolymer includes ethylene and/or propylene monomers and an α-olefin monomer, such as a C₃-C₂₀ α-olefin. Suitable α-olefins may be linear or branched (e.g., one or more C₁-C₃ alkyl branches, or an aryl group). Specific examples include 1-butene, 3-methyl-1-butene, 3,3-dimethyl-1-butene, 1-pentene, 1-pentene, 1-hexene, 1-heptene, 1-octene, 1-nonene, 1-decene, 1-dodecene, styrene, ethylene, etc. The ethylene or propylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %. Particular examples of such copolymers include, for instance, low density polyethylene (“LDPE”), linear low density polyethylene (“LLDPE”), etc. Any of a variety of known techniques may generally be employed to form the olefinic polymers. For instance, such polymers may be formed using a free radical or a coordination catalyst (e.g., Ziegler-Natty or metallocene).

To maintain the desired properties, the majority of the composition used in the protective layer is generally formed from base polymers (e.g., olefinic polymers). That is, about 50 wt. % or more, in some embodiments about 75 wt. % or more, and in some embodiments, about 90 wt % or more (e.g., 100 wt. %) of the composition is formed by base polymers. Nevertheless, the composition used in the protective layer may optionally contain one or more additives as described above, such as flow aids, antimicrobials, pigments, antioxidants, stabilizers, surfactants, waxes, solid solvents, flame retardants, anti-drip additives, and other materials added to enhance properties and processability. When employed, the optional additive(s) typically constitute from about 0.05 wt. % to about 20 wt. %, and in some embodiments, from about 0.1 wt. % to about 15 wt. %, and in some embodiments, from about 0.5 wt. % to about 5 wt. % of the protective layer.

### III. Co-Injection Molding

The multi-layered article of the present invention is formed by “co-injection molding”, which generally refers to a process during which two or more dissimilar materials originating from different sources (e.g., injection units) are injected into a mold during a molding cycle, thereby co-molding one material inside the other material. The inner material is often referred to as the “core” layer while the outer material is often referred to as the “skin” layer. In the present invention, a liquid crystalline polymer composition, such as described above, can be used to form the core or the skin layers. For example, in one embodiment of a two-layered configuration, a liquid crystalline polymer composition may form the core layer and a base polymer composition (e.g., olefinic polymer composition) may form the skin layer. The compositions may be formed in the manner described above. The article may also contain three or more layers. For instance, in one embodiment of a three-layered configuration, the liquid crystalline polymer may form the core layer and the base polymer composition may form skin layers that are positioned adjacent to and surround the core layer.

The molding cycle generally involves co-injecting the dissimilar materials for each layer into a mold cavity. The co-injection can occur in two main phases—i.e., an injection phase and holding phase. During the injection phase, the mold cavity is completely filled with the molten thermoplastic compositions for each layer. The co-injection of the materials can be either simultaneous or sequential. The holding phase is initiated after completion of the injection phase in which the holding pressure is controlled to pack additional material into the cavity and compensate for volumetric shrinkage that occurs during cooling. After the shot has built, it can then be cooled. Once cooling is complete, the molding cycle is completed when the mold opens and the part is ejected, such as with the assistance of ejector pins within the mold.

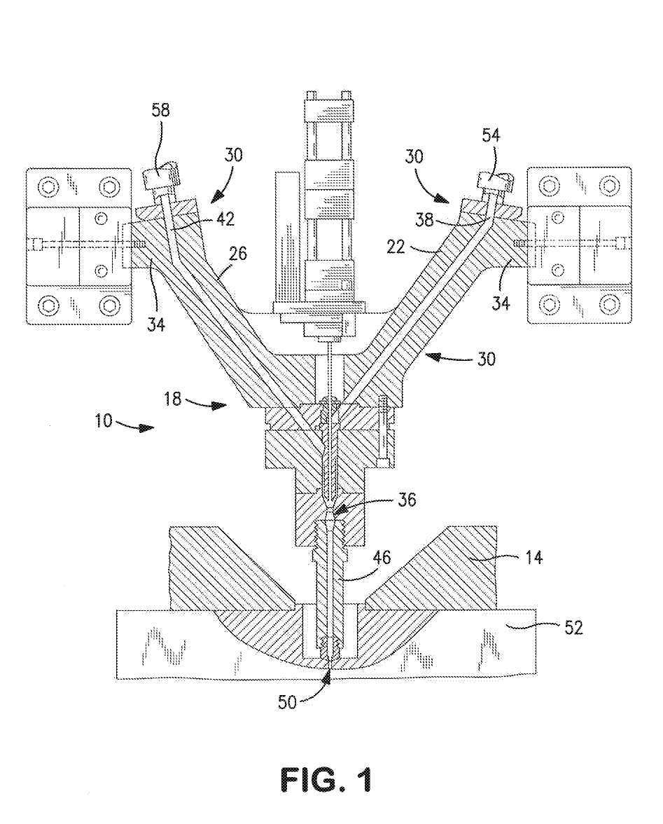

Any suitable co-injection molding equipment may generally be employed in the present invention. Referring to FIG. 1, for example, one embodiment of a co-injection molding apparatus 10 is shown. As shown, the apparatus 10 includes a co-injection manifold 30 mounted relative to a platen 14. The co-injection manifold 30 contains a nozzle housing 18 having forward and rearward ends. The nozzle housing 34 is generally V-shaped and includes angularly spaced first and second or right and left arms 22 and 26. Each arm has a rearward end 30 and includes an outwardly extending mounting portion 34. The nozzle housing 18 has an outlet 36 in its forward end, a first inlet 38 in the rearward end of the first arm 22, and a second inlet 42 in the rearward end of the second arm 26. The outlet 36 communicates with a nozzle 46, which communicates with a mold cavity inlet 50 and ultimately the mold 52 and mold cavity (not shown). The inlets 38 and 42 communicate with injection nozzles 54 and 58 of respective injection units (not shown). In the illustrated construction, the injection nozzle 54 injects the inner core material (e.g., liquid crystalline polymer composition) and the nozzle 58 injects the skin material (e.g., base polymer composition). The polymer compositions may be supplied using a variety of techniques. For example, the compositions may be supplied (e.g., in the form of pellets) to a feed hopper attached to an extruder barrel that contains a rotating screw (not shown). As the screw rotates, the pellets are moved forward and undergo pressure and friction, which generates heat to melt the pellets. Additional heat may also be supplied to the composition by a heating medium that is communication with the extruder barrel. Various other co-injection molding devices may also be used in the present invention as is known in the art, such as described in U.S. Pat. No. 4,376,625 to Eckardt, U.S. Pat. No. 5,650,178 to Bemis, and U.S. Pat. No. 5,891,381 to Bemis.

The co-injection can be either simultaneous or sequential. During simultaneous co-injection, a skin material is injected from a first injection unit (usually through a manifold such as those described above) and into a mold cavity. The flow of the skin material into the mold may then be slowed as the core material from a second source or barrel is injected into the mold, (usually through a co-injection manifold), along with the skin material. In other words, the skin and core mixture may flow concurrently or simultaneously into the mold cavity. This allows the core material to be injected inside the skin material. Subsequently, the skin and core material flow can be terminated substantially simultaneously, or alternatively, the flow of the core material may be stopped while the skin material continues to flow to finish off the part. Alternatively, simultaneous co-injection may involve injecting the skin material from a first source into the mold cavity, then injecting a core material into the mold cavity so that core material and skin material simultaneously enter the mold cavity, terminating the flow of the skin material while allowing the core material to continue to flow, terminating the flow of the core material, and resuming and subsequently terminating the flow of the skin material in order to complete the production of a part.

### IV. Articles

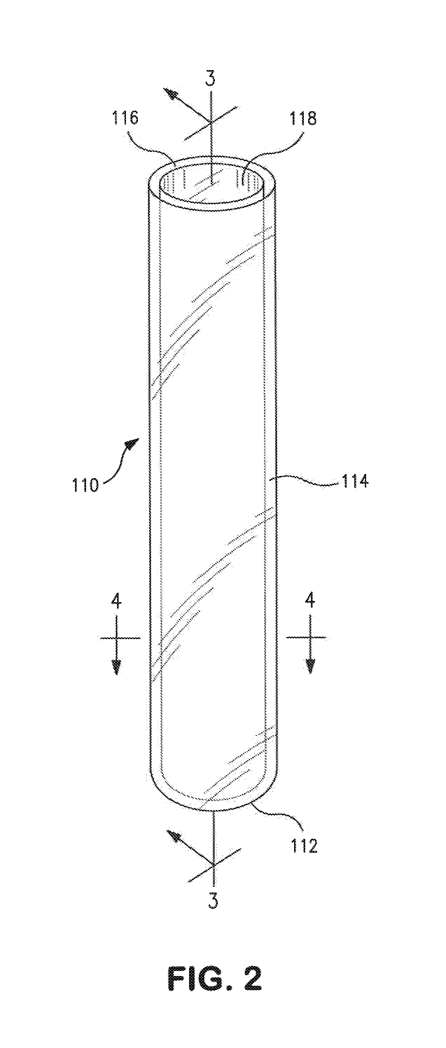

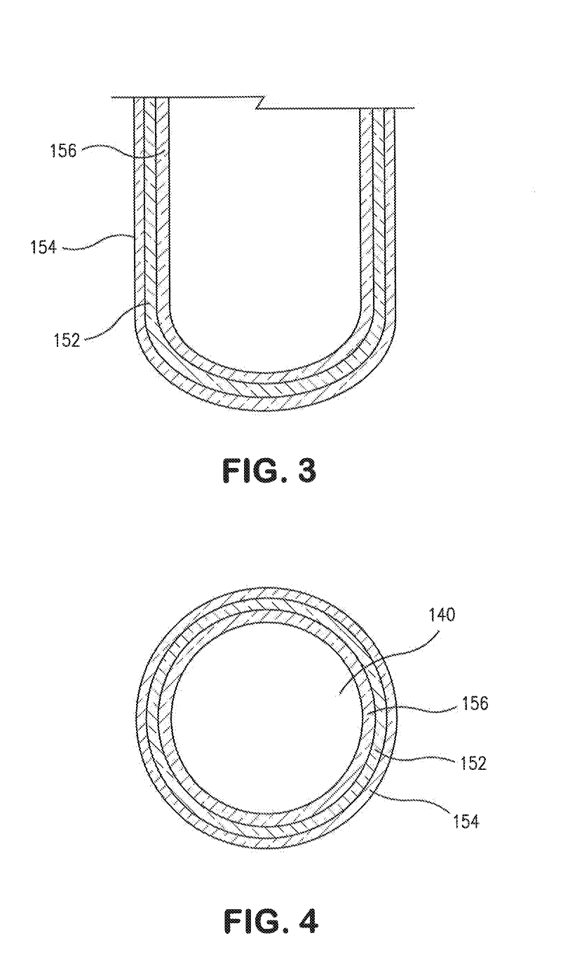

The multi-layered article of the present invention may be employed in a wide variety of applications, such as containers or packaging for food or beverage products, containers or packaging for medical products or materials, containers for biological materials (e.g., blood), etc. Referring to FIGS. 2-4, for instance, one embodiment of a container 110 is shown that can be used to collect biological materials, such as blood. As shown, the container 110 has a bottom wall portion 112 and a sidewall portion 114 continuous therewith. The sidewall portion 114 has a top edge 116 and defines an open end 118. A straight sidewall portion is shown for the container 110, but complex sidewall shapes, for other containers, are also possible. The container 110 of this particular embodiment is formed from discrete layers (see FIGS. 3-4), which include a core layer 152 surrounded by an inner skin layer 156 and an outer skin layer 154. By way of example, the core layer 152 may be a barrier layer that is formed from the liquid crystalline polymer composition, while the skin layers 154 and/or 156 may be protective layers formed from the base polymer composition (e.g., olefinic polymer). Of course, if desired, the liquid crystalline polymer composition may also be employed in a skin layer, or the base polymer composition may be employed in a core layer. Likewise, as noted above, the container may also contain only two layers, or even more than three layers.

Regardless of the particular type of co-injection molded article that is employed, it is generally impervious to gases and moisture due to the presence of the barrier layer of the present invention. For example, the barrier layer and the resulting article may be impervious to gases in that they prevent the mass transfer of gases at typical atmospheric conditions, such as oxygen, carbon dioxide or nitrogen. Oxygen barrier properties, for instance, are typically measured in cm³ mil/100 in²/24 hr/atm. In the present invention, the barrier layer and/or article may have an oxygen transmission rate of about 0.3 cm³ mil/100 in²/24 hr/atm or less, in some embodiments about 0.2 cm³ mil/100 in²/24 hr/atm or less, and in some embodiments, about 0.1 cm³ mil/100 in²/24 hr/atm or less, as determined in accordance with ASTM D3985-05 at a temperature of 23° C. and a relative humidity of 0%. The resistance to the mass transfer of liquid vapors at a certain partial pressure and temperature across a material can be expressed as the moisture vapor transmission rate with the units of g mil/100 in²/24 hr. In the present invention, the barrier layer and/or article may have a moisture vapor transmission rate of about 1 g-mil/100 in²/24 hr or less, in some embodiments about 0.9 g-mil/100 in²/24 hr or less, and in some embodiments, about 0.8 g-mil/100 in²/24 hr or less, determined in accordance with ASTM F1249-06 at a temperature of 100° F. and 90% relative humidity.

If desired, the article may be sterilized using a retort process during which the article and its contents are subjected to heat and/or pressure in a retort apparatus, such as an oven, autoclave, or a thermal bath. For example, retort heat treatments may occur at temperatures of about 100° C. or more. The treatment time can vary depending on the size of the content material and the level of sterilization intended. For example, the treatment time can sometimes range from about 5 minutes to about 1 hour. Notably, one particular benefit of the present invention is that the multi-layered article can maintain oxygen transmission and/or moisture vapor transmission rates within the same ranges noted above even after being subjected to a retort process, thus allowing it to still provide the desired gas and/or moisture vapor properties.

### Test Methods

Melt Viscosity:

The melt viscosity (Pa-s) may be determined in accordance with ISO Test No. 11443 at a shear rate of 1000 s⁻¹ and temperature 15° C. above the melting temperature (e.g., about 235° C.) using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm 0.005 mm and the length of the rod was 233.4 mm.

Complex Viscosity:

Complex viscosity is a frequency-dependent viscosity, determined during forced harmonic oscillation of shear stress at angular frequencies of 0.1 to 500 radians per second. Prior to testing, the sample is cut into the shape of a circle (diameter of 25 mm) using a hole-punch. Measurements are determined at a temperature 15° C. above the melting temperature (e.g., about 235° C.) and at a constant strain amplitude of 1% using an ARES-G2 rheometer (TA Instruments) with a parallel plate configuration (25 mm plate diameter). The gap distance for each sample is adjusted according to the thickness of each sample.

Melting Temperature:

The melting temperature (“Tm”) was determined by differential scanning calorimetry (“DSC”) as is known in the art. The melting temperature is the differential scanning calorimetry (DSC) peak melt temperature as determined by ISO Test No. 11357. Under the DSC procedure, samples were heated and cooled at 20° C. per minute as stated in ISO Standard 10350 using DSC measurements conducted on a TA Q2000 Instrument.

Melt Elongation:

Melt elongation properties (i.e., stress, strain, and elongational viscosity) may be determined in accordance with the ARES-EVF: Option for Measuring Extensional Velocity of Polymer Melts, A. Franck, which is incorporated herein by reference. In this test, an extensional viscosity fixture (“EVF”) is used on a rotational rheometer to allow the measurement of the engineering stress at a certain percent strain. More particularly, a thin rectangular polymer melt sample is adhered to two parallel cylinders: one cylinder rotates to wind up the polymer melt and lead to continuous uniaxial deformation in the sample, and the other cylinder measures the stress from the sample. An exponential increase in the sample length occurs with a rotating cylinder. Therefore, the Hencky strain (ε_{H}) is determined as function of time by the following equation: ε_{H}(t)=ln(L(t)/Lₒ), where Lₒ is the initial gauge length of and L(t) is the gauge length as a function of time. The Hencky strain is also referred to as percent strain. Likewise, the elongational viscosity is determined by dividing the normal stress (kPa) by the elongation rate (s⁻¹). Specimens tested according to this procedure have a width of 1.27 mm, length of 30 mm, and thickness of 0.8 mm. The test may be conducted at the melting temperature (e.g., about 220° C.) and elongation rate of 2 s⁻¹.

Water Vapor Transmission Rate (“WVTR”):

The water vapor transmission rate is determined in accordance with ASTM F1249 at a temperature of 37.7° C. and relative humidity of 90%. In this method, a dry chamber is separated from a wet chamber of known temperature and humidity by the barrier material to be tested. Water vapor diffusing through the film mixes with the gas in the dry chamber and is carried to a pressure-modulated infrared sensor. The sensor measures the fraction of infrared energy absorbed by the water vapor and produces an electrical signal, the amplitude of which is proportional to water vapor concentration. The amplitude of the electrical signal produced by the test film is then compared to the signal produced by measurement of a calibration film of known water vapor transmission rate. This information is then used to calculate the rate at which moisture is transmitted through the material being used. A foil mask is used to mount the sample with a circular size of 50 cm². It consists of two square pieces of adhesive backed foil with circular cut-outs in the center. The sample is placed between the two pieces, attached by the adhesive. The cut out is 50 cm² in size.

Oxygen Transmission Rate:

The oxygen transmission rate is determined in accordance with ASTM D3985 at a temperature of 23° C. and relative humidity of 0%. In this test, the oxygen gas transmission rate is determined after the sample has equilibrated in a dry test environment, which is considered to be one in which the relative humidity is less than 1%. The specimen is mounted as a sealed semi-barrier between two chambers at ambient atmospheric pressure. One chamber is slowly purged by a stream of nitrogen and the other chamber contains oxygen. As oxygen gas permeates through the film into the nitrogen carrier gas, it is transported to the coulometric detector where it produces an electrical current, proportional to the amount of oxygen flow rate into the detector.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A multi-layered, co-injection molded article comprising:
a barrier layer that comprises a thermotropic liquid crystalline polymer having a melting temperature of from about 190° C. to about 360° C., the liquid crystalline polymer comprising aromatic ester repeating units; and
a protective layer that comprises a base polymer, wherein the ratio of the melting temperature of the liquid crystalline polymer to the melting temperature of the base polymer is from about 1.00 to about 1.70.

2. The multi-layered, co-injection molded article of claim 1, wherein the ratio of the melting temperature of the liquid crystalline polymer to the base polymer is from about 1.05 to about 1.50.

3. The multi-layered, co-injection molded article of claim 1, wherein the melting temperature of the liquid crystalline polymer is from about 190° C. to about 260° C.

4. The multi-layered, co-injection molded article of claim 1, wherein the liquid crystalline polymer has a storage modulus of about 1000 Pa or less, as determined at the melting temperature of the polymer and at an angular frequency of 0.1 radians per second.

5. The multi-layered, co-injection molded article of claim 1, wherein the liquid crystalline polymer has a complex viscosity of about 1,500 Pa-s or less at angular frequencies ranging from 0.1 to 1000 radians per second, as determined by a parallel plate rheometer at 15° C. above the melting temperature of the polymer and at a constant strain amplitude of 1%.

6. The multi-layered, co-injection molded article of claim 1, wherein the liquid crystalline polymer has a melt viscosity of from about 1 to about 150 Pa-s, as determined in accordance with ISO Test No. 1143 at 15° C. above the melting temperature of the liquid crystalline polymer.

7. The multi-layered, co-injection molded article of claim 1, wherein the aromatic ester repeating units include aromatic dicarboxylic acid repeating units, aromatic hydroxycarboxylic acid repeating units, and aromatic diol repeating units.

8. The multi-layered, co-injection molded article of claim 7, wherein the aromatic hydroxycarboxylic acid repeating units are derived from 4 hydroxybenzoic acid, 6-hydroxy-2-naphthoic acid, or a combination thereof, the aromatic dicarboxylic acid repeating units are derived from terephthalic acid, isophthalic acid, or a combination thereof, and the aromatic diol repeating units are derived from hydroquinone, 4,4′-biphenol, or a combination thereof.

9. The multi-layered, co-injection molded article of claim 1, wherein the base polymer is an olefinic polymer, polyester, polyimide, polyamide, or a combination thereof.

10. The multi-layered, co-injection molded article of claim 9, wherein the olefinic polymer is a homopolymer of propylene.

11. The multi-layered, co-injection molded article of claim 1, wherein about 50 wt. % or more of the barrier layer is formed by liquid crystalline polymers and about 50 wt. % or more of the protective layer is formed by base polymers.

12. The multi-layered, co-injection molded article of claim 1, wherein the article has a skin-core configuration in which the barrier layer forms the core and the protective layer forms the skin.

13. The multi-layered, co-injection molded article of claim 1, wherein the article has a skin-core-skin configuration in which the barrier layer forms the core and the protective layer forms the skin.

14. The multi-layered, co-injection molded article of claim 1, wherein the article exhibits an oxygen transmission rate of about 0.3 cm³ mil/100 in²/24 hr/atm or less, as determined in accordance with ASTM D3985-05 at a temperature of 23° C. and a relative humidity of 0%.

15. The multi-layered, co-injection molded article of claim 1, wherein the article exhibits a moisture vapor transmission rate of about 1 g-mil/100 in²/24 hr or less, as determined in accordance with ASTM F1249-06 at a temperature of 100° F. and 90% relative humidity.

16. The multi-layered, co-injection molded article of claim 1, wherein the article is a container or packaging for food, medical products, or biological materials.

17. A method for forming a multi-layered article, the method comprising:
co-injecting a liquid crystalline polymer composition and a base polymer composition into a mold cavity, wherein the base polymer composition comprises a base polymer and the liquid crystalline polymer composition comprises a thermotropic liquid crystalline polymer having a melting temperature of from about 190° C. to about 360° C., the liquid crystalline polymer comprising aromatic ester repeating units, and further wherein the ratio of the melting temperature of the liquid crystalline polymer to the melting temperature of the base polymer is from about 1.00 to about 1.70; and
cooling the co-injected compositions to form the article.

18. The method of claim 17, wherein the ratio of the melting temperature of the liquid crystalline polymer to the base polymer is from about 1.05 to about 1.50.

19. The method of claim 17, wherein the aromatic ester repeating units include aromatic dicarboxylic acid repeating units, aromatic hydroxycarboxylic acid repeating units, and aromatic diol repeating units, and wherein the base polymer is an olefinic polymer.

20. The method of claim 17, wherein the base polymer is an olefinic polymer.
